(19) United States
(12) Patent Application Publication
(10) Pub. No.: US 2002/0062161 A1
(43) Pub. Date: May 23, 2002

(54) Automated method and apparatus for the non-cutting shaping of a body

(76) Inventor: Carsten Dusterhoft, Baunatal (DE)

Correspondence Address: George M. Thomas, Thomas, Kayden, Horstemeyer & Risley, LLP, Suite 1750, 100 Galleria Parkway, NW, Atlanta, GA, 30339-5948, US

(21) Appl. No.: 10/035,562

(22) Filed: Oct. 23, 2001

Related U.S. Application Data
(63) Continuation of application No. PCT/EP00/03565, filed on Apr. 19, 2000.

(30) Foreign Application Priority Data
Apr. 23, 1999 (DE) 199 18 424.0-16
Jan. 12, 2000 (DE) 100 00 859.3

(51) Int. Cl. G06F 17/00; G06F 19/00

(52) U.S. Cl. 700/98

(57) ABSTRACT

An automated method of shaping a thin side wall of a body without cutting includes the steps of predetermining a desired geometry of the thin side wall of the body in an electronic data model, automated determining the actual geometry of the thin side wall of the body and storing it in an electronic data model, calculating the difference between the desired geometry and the actual geometry of the thin side wall of the body, determining local deformation zones in which the difference between the desired geometry and the actual geometry of the thin side wall of the body exceeds a defined predetermined limiting value, calculating an energy profile to be locally applied in the local deformation zones by numerical methods, applying defined pressure to one side of the thin side wall of the body, and defined, automated increasing the deformability of the thin side wall of the body in the local deformation zones by a defined application of energy in the local deformation zones in accordance with the calculated local energy profile, the thin side wall of the body in the local deformation zones being deformed due to its increased deformability and the one-side application of pressure. An apparatus serves to conduct the method.

### CROSS REFERENCE TO RELATED APPLICATIONS

This is a continuation of International Application PCT/EP00/03565 with an international filing date of Apr. 19, 2000.

### FIELD OF THE INVENTION

The present invention generally relates to a method of deforming or shaping a thin side wall of a body. More particularly, the present invention relates to an automated method of shaping a thin side wall of a body without cutting. The present invention also relates to an apparatus for shaping a thin side wall of a body without cutting in an automated way.

### BACKGROUND OF THE INVENTION

A method of deforming a thin side wall of a body without cutting is known from Japanese Patent 08001760 A. The body to be deformed is a hollow body which has a closed design except one opening being arranged at one end. The hollow body with its end carrying the opening is fixed in a fixing apparatus. The entire hollow body is heated until it reaches great deformability. In this state of the hollow body, a fluid is blown into the opening of the hollow body. The end of the hollow body facing away from the opening is moved by a pulling rod or a pushing rod until the hollow body reaches the desired end form. The distribution of energy may only be roughly controlled. This is not sufficient to produce fine and exact contours. The exact production of a locally defined thickness of the wall of the finished body is not possible.

Another method of shaping a thin side wall of a body without cutting is known as blow moulding without counter form. The body to be deformed is clamped in a clamping frame, and it is uniformly heated. Overpressure is produced within the clamping frame such that the entire body having thin walls is deformed towards the outside. The produced contour, for example a cupola, always has the same shape. The distribution of energy may only be roughly controlled. This is not sufficient to produce fine and exact contours. The exact production of a locally defined thickness of the wall of the finished body is not possible.

Another method of deforming a thin side wall of a body without cutting is known as glass blowing. In this manual method, the hollow body made of glass is heated by a flame in great regions of its surface to an extent until the desired deformability has been reached. Then, the glass blower applies air pressure to the inside of the hollow body by blowing into the hollow body. The attainable exactness of the deformation strongly depends on the skills of the glass blower. Differences with respect to the desired geometry of the body are not measured in an exact way, but they are only roughly assessed. Especially, it is very difficult to produce exact 3D free form surfaces. It is not possible to check the results by measuring. Thus, exact corrections cannot be realized. Another disadvantage of the known manual work results from the fact that exact production of a locally defined thickness of the wall of the finished body is not possible. The thickness of the material of the blown hollow body cannot be controlled with respect to the surface coordinate, but it has to be accepted as it is reached in the deformation process. Regions which are mostly lengthened will be the thinnest after the deformation process has been finished. Consequently, a blank has to have enough material at the beginning of the deformation process to make sure that the finished body at its weakest point still is strong enough to withstand the necessary loads. In this way, the body at many places has more material than necessary. This results in a relatively great mass of the body. In case of the known manual work, the quality of the finished surface is even less measurable than the exactness of the shape of the body. Waviness and other uneven places of the surface which result from the manual process cannot be compensated. Furthermore, it is not possible to realize a purposefully structured change of the deformability of the material of the body with manual work. The distribution of the heat can only be roughly controlled which leads to errors during the deformation process.

Automated blowing methods for deforming a thin side wall of a body without cutting are also known. The used blowing machine has to be adjusted for the production of a certain geometry of the body. The known methods are only suitable for glass and for thermal plastics. It is not possible to produce a locally defined wall thickness of the finished body.

### SUMMARY OF THE INVENTION

The present invention generally relates to a method of deforming or shaping a thin side wall of a body. More particularly, the present invention relates to an automated method of shaping a thin side wall of a body without cutting which includes the steps of predetermining a desired geometry of the thin side wall of the body in an electronic data model, automated determining the actual geometry of the thin side wall of the body and storing it in an electronic data model, calculating the difference between the desired geometry and the actual geometry of the thin side wall of the body, determining local deformation zones in which the difference between the desired geometry and the actual geometry of the thin side wall of the body exceeds a defined predetermined limiting value, calculating an energy profile to be locally applied in the local deformation zones by numerical methods, applying defined pressure to one side of the thin side wall of the body, and defined, automated increasing the deformability of the thin side wall of the body in the local deformation zones by a defined application of energy in the local deformation zones in accordance with the calculated local energy profile, the thin side wall of the body in the local deformation zones being deformed due to its increased deformability and the one-side application of pressure.

In the automated method of shaping a thin side wall of a body without cutting, at first the desired geometry of the thin side wall of the body is predetermined in an electronic data model. The actual geometry of the thin side wall of the body to be deformed is also determined in an automated way, and it is stored in an electronic data model. The difference between the desired geometry and the actual geometry is calculated by a comparison of the determined actual geometry and the predetermined desired geometry of the thin side wall of the body. Local deformation zones in which the difference between the desired geometry and the actual geometry exceeds a predetermined limit value are determined. An energy profile to be locally applied in the local deformation zones is calculated by numerical methods. One side of the thin side wall of the body is subjected to defined pressure. The deformability of the thin side wall of the body is increased in a defined automated way in the local deformation zones by defined application of energy in the local deformation zones according to the calculated local energy profile. The thin side wall of the body is deformed in the local deformation zones due to its defined increased deformability and the one-side application of pressure.

The automated method starts from the presence of an electronic data model of the body. For example, the data may be CAD data or image data of the finished product. The desired geometry of the body is attained by a stepwise deformation of the blank by increasing deformability of the thin side wall of the body in one or more local deformation zones. A local deformation zone in which deformability has been increased is to be understood as a small partial zone in which the calculated position-dependent temperature profile has been introduced. It is also possible that a plurality of local deformation zones commonly forms a global deformation zone which has an inhomogeneous profile. The local deformation zones themselves may have an inhomogeneous temperature profile. The thin side wall may be an outer wall or an inner wall of the body. Due to the pressure difference between the side of the side wall of the body which is subjected to the pressure of the pressure medium and the side of the side wall of the body being subjected to ambient pressure, the thin side wall of the body as being formed at sufficient deformability and elastic-plastic deformability, respectively. Local deformation zones in which the difference between the desired geometry and the actual geometry exceeds a predetermined limit value are calculated. The energy profile to be applied and the necessary pressure difference are calculated within these deformation zones. The parameters may be determined by solving the continuum mechanics differential equations by numerical methods. Other calculating methods, as fuzzy logic, neuronal networks and the like may also be applied and they are known to one with skill in the art.

The novel method may include one step in the sense of each portion of the side wall of the body only being deformed one time. However, a stepwise proceeding, meaning an iterative method, is preferred to keep little tolerances between the actual geometry reached by deformation and the predetermined desired geometry. In the stepwise method, at least the detection of the actual geometry of the thin side wall of the body is repeated after the first deformation step. In case the following calculation of an still existing difference between the desired geometry and the actual geometry from a comparison of the well determined actual geometry with the predetermined desired geometry of the thin side wall of the body proves that the predetermined limit value is kept, the method may be stopped.

However, when the limit value is at least partially exceeded, the local deformation zones in which the difference between the desired geometry and the actual geometry exceeds a predetermined limit value are determined to apply another deformation step to them.

When a body is deformed, there is an edge which separates the portions which already have the desired geometry and the portions which still need to be deformed. Partial portions or the entire zone to be deformed may be subjected to energy in the respective portions to be deformed. In case these portions are small, the respective temperature profile to be applied may be constant within that portion. Usually, the temperature profile in the respective portion to be deformed is inhomogeneous. As an example, one may think of a finished head of a doll which is produced from a blank having the shape of an egg. When the blank in the region of the rear head already has the desired geometry, the face still needs to be processed. In this case, the course of the edge is clear. However, it is also possible that, for example, the cheeks also already have the desired geometry, but eyes, mouth, nose and the chin still need to be deformed. Then, the face forms the global information zone and the sided portions, eyes, mouth, nose, chin are the local deformation zones. To shape the nose, one needs an inhomogeneous temperature profile in these local deformation zones. When the actual geometry still is different from the desired geometry the face of the head of the doll has to be processed as a whole. The temperature profile is inhomogeneous.

The body may be shaped without using a form. This is especially advantageous in case of job lots and individual products. Not using a form has the advantage of the set up time being reduced and no additional costs being necessary for the production of forms.

The defined pressure may be applied to the one side of the tin side wall of the body by compressed air or by a hydraulic medium, preferably by a hydraulic oil. The hydraulic application of pressure has the advantage of the heating effect of the body being reduced by the hydraulic medium to a base temperature, and of the deformation zone of the body cooling down faster. The pressure applied to the thin side wall of the body may be constant. This has the advantage of only the choice of the deformation zones and the term of usage and the intensity of the application of energy, respectively, remaining as parameters, while the pressure remains unchanged. For example, it is possible to use pressure of one value for one material. However, it is also possible to use different pressures in case of different materials of the body depending on deformability of the respective materials. It makes sense to use greater pressure to process metals than it is the case with plastics. Furthermore, one may vary pressure as another parameter during the deformation process.

The actual geometry of the thin side wall of the body may be continuously determined and the application of energy may be controlled with respect thereto. An energy profile to be applied is determined in intervals, the energy profile increasing deformability of the thin side wall of the body in the local deformation zone in a defined way. In this way, it is possible to attain great exactness in the deformation process of the thin side wall of the body. Consequently, an amount of energy which is less than calculated may first be applied in the local deformation zone to be processed. Then, the deformation resulting therefrom is determined and measured. The necessary increase of deformability of the body is determined depending on the now determined actual geometry. This process is repeated until the difference between the desired geometry and the actual geometry does no longer exceed the predetermined limit value. However, it is also possible to deform the body in one step when the parameters necessary therefore are sufficiently known. Especially with bodies which do not require great processing exactness, it is useful to only apply one or a few deformation steps in the local deformation zone.

The energy profile to be locally applied may be newly calculated for each deformation step in the local deformation zones, and it may be applied to the body in a respective way. In so this way, great exactness of the desired deformation of the body is realized.

The thin side wall has a thickness which may be varied by purposefully choosing the respective local deformation zone. This also means that the thickness of the body does not necessarily have to be constant over the entire surface of the body. One and the same outer geometry of the body may be realized with different local deformation zones, the thickness of the side wall of one body having a different design than the thickness of another body. A variation of the thickness of the side wall of the body makes special sense when an increased thickness is necessary to structurally strengthen the body and the component, respectively, in certain portions. However, it is not the entire body that needs to have this thickness.

Consequently, the mass and the weight, respectively, of the body is advantageously reduced.

The defined application of energy in accordance with the calculated local energy profile may be realized by a laser beam. A laser beam may be well controlled in a way that the surface of the thin side wall of the body is scanned in the desired deformation zone. The laser beam has the desired exactness and the possibility of exactly choosing the intensity of the energy application. Due to the strongly limited local application of energy, it is possible to produce very thin energy profiles and very thin contours with the laser beam. Generally, it is also possible to use different sources of energy for the application of energy. For example, a radiant heater may be used.

The deformability of the thin side wall of the body may be varied by a variation of the term of usage, the intensity, the pulse width or the focus size of the laser beam. It is important that the deformability is influenced in a defined way such that a reliably predictable deformation in the deformation zone of the body is attained.

The local deformation zones may be cooled after the desired deformation of the thin side wall of the body has been reached. In this way, the necessary processing time for the deformation of the body is reduced.

The novel method may also be called FDS method (Flexible Direct Shaping). The method provides a number of advantages: all bodies may be produced at great shape exactness, defined wall thickness and great quality. These parameters may be measured and controlled at great exactness. The production process is strongly accelerated since functional products are quickly available. Each body may just be produced without a lot of preparation in case an electronic data model is available. The costs are enormously reduced, especially in the production of individual products, single products and job lots and medium size production lines since it is not necessary to produce complicated forms. The saving of time is enormous. The more complicated the body to be produced is, for example a prosthesis, the faster is the method compared to known production methods. Production times are almost independent from the size of the body. The processing times of a body and of a workpiece mostly depends on the fact how similar the form of the blank is compared to the body to be produced. Generally, the FDS method may be used for all deformable materials. It is also possible to process bodies which include different deformable materials. All regional forms may be processed. Preformed form surfaces and other workpieces (ribs and so forth) may be maintained unchanged. Only portions in which the desired geometry and the actual geometry are different have to be deformed. The integration of other standard components is also possible. Very complicated, angled form elements, for example undercuts, may be manufactured as one piece. Mostly, no following processing steps (connecting semi shells and so forth) are necessary. Already finished bodies may be quickly changed. An already existing and already used body may also be used as this is the case with any blank. Old bodies may be reused, standard blanks may be quickly adapted and changed with respect to individual desires. Due to the fact that the method works without direct contact, there is no wear and tear of tools. The use of lubricants or the like is not necessary. The FDS method especially has advantages in the field of the production of small and medium series of products as well as individual products. With the method, the production of individual products substantially is not more complicated than the production of similar standard products. Instead of using different form tools, the existence of a data model is sufficient to directly produce a product with the FDS method. The actual production time for an individual product—depending on the intensity of the deformation work to be conducted—only takes a few seconds up to a few minutes. Consequently, production costs are reduced and they are similar to the ones of known methods.

The present invention also relates to an apparatus for shaping a body having at least one thin side wall without cutting. The apparatus includes a unit being designed and arranged to automatedly determine and store the actual geometry of the thin side wall of the body in an electronic data model. A computer is designed and arranged to predetermine a desired geometry of the thin side wall of the body in an electronic data model, to calculate the difference between the desired geometry and the actual geometry by a comparison of the determined actual geometry and the predetermined desired geometry of the thin side wall of the body, to determine local deformation zones in which the difference between the desired geometry and the actual geometry of the thin side wall of the body exceeds a defined predetermined limiting value and to calculate an energy profile to be locally applied in the local deformation zones. A controllable pressure unit is designed and arranged to apply defined pressure to one side of the thin side wall of the body. A unit is designed and arranged to increase the deformability of the thin side wall of the body in the local deformation zones in a defined, automated way by a defined application of energy in the local deformation zones in accordance with the calculated local energy profile, the thin side wall of the body in the local deformation zones being deformed due to its increased deformability and the one-side application of pressure.

The unit for automatedly detecting the actual geometry of the thin side wall of the body in an electronic data model serves to determine the existing geometry of the body and of the workpiece, respectively, to determine the process steps to be conducted. Especially, the exactness of the contour data, the velocity of the detection of data and the completeness of the detected data is of importance.

The pressure apparatus may be a compressed air apparatus. However, it is also possible to use a pressure apparatus which works with a hydraulic medium.

The actual geometry of the thin side wall of the body may be detected by a 3D object measuring system. The 3D object measuring system includes a digital camera and respective control units and the respective software. As an alternative to the object measuring system with a digital camera, it is also possible to use supersonics, radar, Ilidar and any other distance sensors.

There may be a cooling apparatus for cooling the local deformation zones after the desired deformation of the thin side wall of the body has been reached. Due to the fast cooling process of the body in the previously heated deformation zones, the necessary processing time for the deformation of the body may be further reduced.

The body and/or the apparatus for automatedly increasing deformability in a defined way may be moved for the application of energy in a certain local deformation zone. It is to be made sure that each place of the thin side wall of the body to be manipulated may be reached for the application of energy.

To change the deformability of the body to be shaped in the actual local deformation zone, energy is applied such that the body—depending on the material of the body—reaches a temperature in which deformation takes place due to the pressure applied by compressed air. The energy may be applied in different ways. For example, the apparatus for a defined increase of the deformability may be a laser. The laser beam of the laser is controlled in a way that the local energy profile is introduced in the local deformation zone of the body to be deformed, for example by scanning with the laser beam or by a controllable micro mirror system. It is also possible to use a localized stream of hot air instead. The entire deformation or shaping process may be simulated by a computer aided simulation. Due the simulation, the parameters to be adjusted, for example temperature, intensity of the energy source and the pressure of the compressed air can be determined. FEM simulation programs which allow for a calculation of the extension of the body at sufficient exactness may be used for this purpose. Other methods, as for example fuzzy logic, neuronal networks and so forth may be used. All necessary material parameters, as for example the elastic module, temperature and so forth may be varied over the surface of the body as it is desired.

The existing temperature profile of the material in the deformation zone of the body may be determined by an infrared camera or by a different thermographical method. The energy profile that needs to be applied is determined with respect thereto.

Robots and moving units are suitable to control the relative movement between the workpiece and the tool. In case the body is a relatively flat form body which only needs average exactness of production, it may be sufficient to use an apparatus for moving the energy supply which only has two axes. In case of elongated hollow bodies, the FDS system also includes two axes to position the energy supply and an additional axis of rotation for the rotation of the body.

For example, in case a laser is used to apply energy, the laser beam may be deflected to the desired position of the surface of the body to be processed by a quickly turning mirror. It is important that the calculated energy profile is introduced with the necessary exactness.

Besides the pure deformation, it is also possible to integrate different already known methods. Cutting certain portions off after the shaping process has been finished, connecting the deformed body to other formed portions by welding, heating up the material to heal the surface of the body, melting the material to additionally change the thickness of the side wall due to the produced flow of material (flow melting) and sintering for a purposefully application of material in certain portions of the body are examples of these known methods.

With the novel method and apparatus for shaping a thin side wall of a body without cutting, it is possible to produce bodies in job lots in a flexible, economical and automated way.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 illustrates a first embodiment of an automated apparatus for shaping a body in the state before the deforming process takes place.

FIG. 2 illustrates an apparatus according to FIG. 1 after the deformation of a deformation zone of the body took place.

FIG. 3 illustrates the apparatus according to FIG. 1 with the use of a partial form.

FIG. 4 illustrates the apparatus according to FIG. 1 with a body including a preformed form element.

FIG. 5 illustrates the apparatus according to FIG. 4 with the deformed body.

FIG. 6 illustrates a second embodiment of the apparatus including a plate-like body in its state before deformation.

FIG. 7 illustrates the apparatus according to FIG. 6 with the deformed plate-like body.

FIG. 8 illustrates the deformation of a thin side wall of a body having defined thickness.

FIG. 9 illustrates a third embodiment of the apparatus with a body with a body with a double chamber in the state before its deformation.

FIG. 10 illustrates the apparatus according to FIG. 9 with the deformed body.

### DETAILED DESCRIPTION

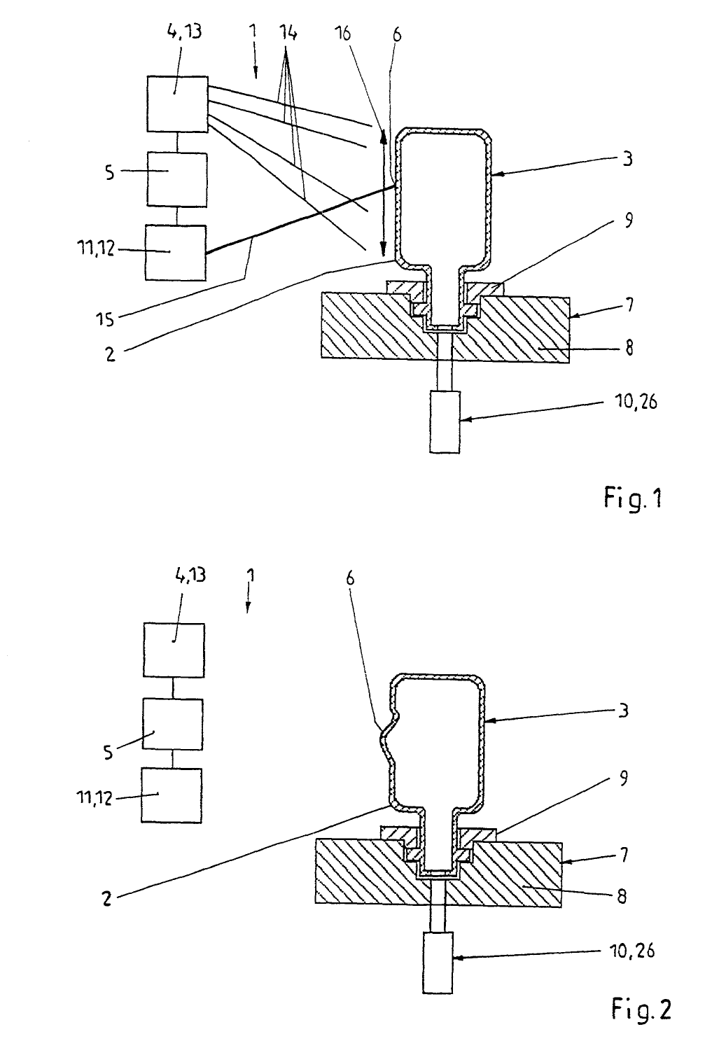

Referring now in greater detail to the drawings, FIG. 1 illustrates a first embodiment of an apparatus for automatedly shaping a thin side wall 2 of a body 3 without cutting. The body 3 is made of plastic. However, the body 3 could also be made of metal, glass, a composite material or a different deformable maternal. The apparatus 1 includes a unit 4 for automatedly determining the actual geometry of the thin side wall 2 of the body 3 in an electronic data model. A computer 5 serves to predetermine or to set the desired geometry of the thin side wall 2 of the body 3 in an electronic data model, to calculate the difference between the desired geometry and the actual geometry from a comparison of the determined actual geometry and the predetermined desired geometry of the thin side wall 2 of the body 3, to determine local deformation zones 6 (FIG. 2) in which the difference between the desired geometry and the actual geometry and the actual geometry exceeds a predetermined limit value and to calculate an energy profile to be locally applied in the local deformation zones 6. Additionally, the apparatus 1 includes a clamping apparatus 7 for clamping the body 3. The clamping apparatus 7 includes a bass plate 8 and a locking device 9. The interior of the body 9—which in this case is designed as a hollow body—is connected to a controllable pressure apparatus 26 in the form of a compressed air apparatus 10 by the clamping apparatus 7. The controllable compressed air apparatus 10 serves to apply compressed air of defined pressure to the interior of the body 3 and to the side wall 2 to be deformed. However, it is also possible to use a pressure apparatus 26 which works with a hydraulic medium instead. Finally, the apparatus 1 includes an apparatus 11 for increasing the deformability of the thin side wall 2 of the body 3 in the local deformation zones 6 in a defined, automated way by applying energy in the local deformation zones 6 in a defined way according to the calculated local energy profile. The apparatus 11 is designed as a laser 12.

FIG. 1 illustrates the apparatus 1 at the beginning of the deformation or shaping process of the body 3. First of all, the desired geometry of the body 3 is predetermined or set in an electronic data model. The desired geometry may be generated of existing CAD data of the body 3 or, for example, by measuring a model of the finished body 3. The desired geometry is stored in a computer 5. Then, the blank and the body 3 to be processed, respectively, is clamped in the clamping apparatus 7 and its actual geometry is measured by the unit 4 for determining the geometry. The unit 4 for determining the geometry is a 3D object measuring system 13 which gathers the geometry data of the body 3, as this is symbolized by the beams 14. The object measuring system 13 is connected to the computer 5 to transmit the determined actual data of the body 3. The data of the determined actual geometry is compared to the predetermined desired geometry of the finished body 3 by the computer 5 and the difference between the desired geometry and the actual geometry is calculated. The local deformation zones 6 in which the difference between the desired geometry and the actual geometry exceeds a predetermined limit value are determined in accordance with the differences between the desired geometry and the actual geometry. In case the determined difference between the desired geometry and the actual geometry does not exceed the limit value, deformation of the thin side wall 2 of the body 3 is not necessary. The computer 5 calculates an energy profile to be locally applied in the local deformation zones 6 by numerical methods. According to the calculated local energy profile, deformability of the thin side wall 2 of the body 3 in the local deformation zones is increased in the local deformation zones 6 in a defined way by a defined application of energy. For the deformation of the local deformation zones 6, a laser beam 15 is moved by the laser 12 in the direction of arrow 16 along the surface of the body 3 to be processed such that the energy necessary for increasing deformability of the thin side wall 2 of the body 3 is applied to the respective deformation zone 6. The amount of energy and the level of deformability, respectively, of the body 3 is varied by a variation of the term of usage, intensity, pulse width or focus size of the laser beam 15. Due to the application of pressure to the side wall 2 of the body 3 to be deformed by the compressed air apparatus 10, the desired deformation of the body 3 results exclusively in the actual local deformation zone 6 towards the direction of less pressure.

The result of the deformation in the local deformation zone 6 is illustrated in FIG. 2. It is to be seen that a deformation of the thin side wall 2 of the body 3 only took place in the deformation zone 6 of the body 3 in which a respective amount of energy has been applied by the laser 12 to increase deformability of the body 3. The other regions or zones of the body 3 remain unchanged, but they may be deformed during following processing steps.

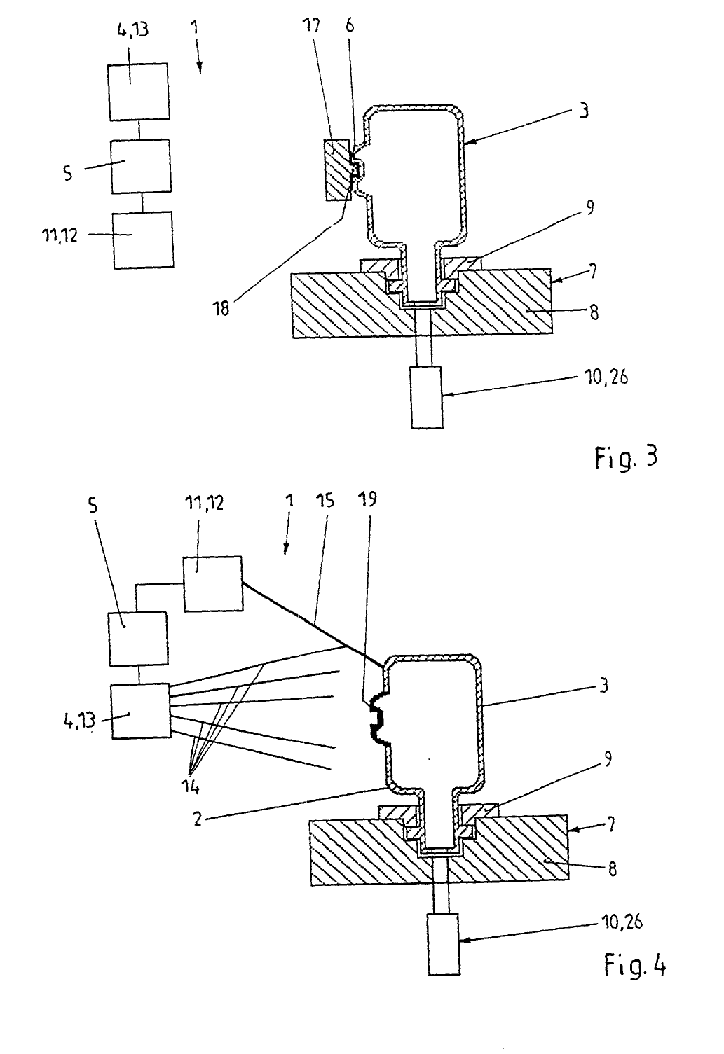

FIG. 3 illustrates the additional use of a partial form 17. After the increase of the deformability of the thin side wall 2 of the body 3 has been reached by the laser beam 12, the partial form 17 is brought into contact with the deformation zone 6 of the body 3. Then, the pressure supplied by the compressed air apparatus 10 and being directed towards the outside is applied to the inner side wall 2 of the body 3 such that the protrusion 18 of the partial form 17 produces the desired geometry in this region of the body 3.

FIG. 4 illustrates a slightly different embodiment of the apparatus 1. The body 3 includes a preformed form element 19 which already is part of the blank.

FIG. 5 illustrates the body 3 according to FIG. 4 after the deformation in the deformation zone 6.

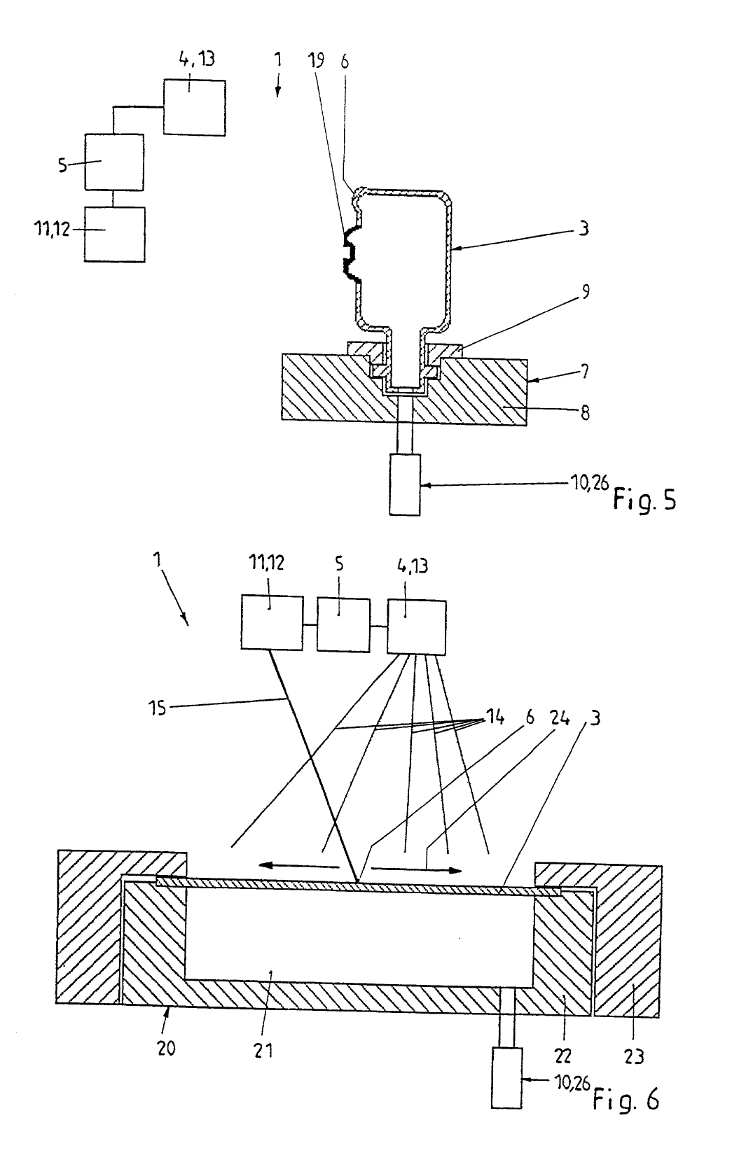

FIG. 6 illustrates another embodiment of the apparatus 1. The body 3 is not designed as a hollow body, but in the form of plane plates. The plate-like body 3 is clamped in a clamping apparatus 20 including a pressured chamber 21 to supply the necessary pressure. The clamping apparatus 20 includes a body 22 and a closing device 23. In this embodiment, again a relative movement takes place between the laser beam 15 and the body 3 according to arrow 24 such that the laser beam 15 generally may reach almost all regions of the body 3.

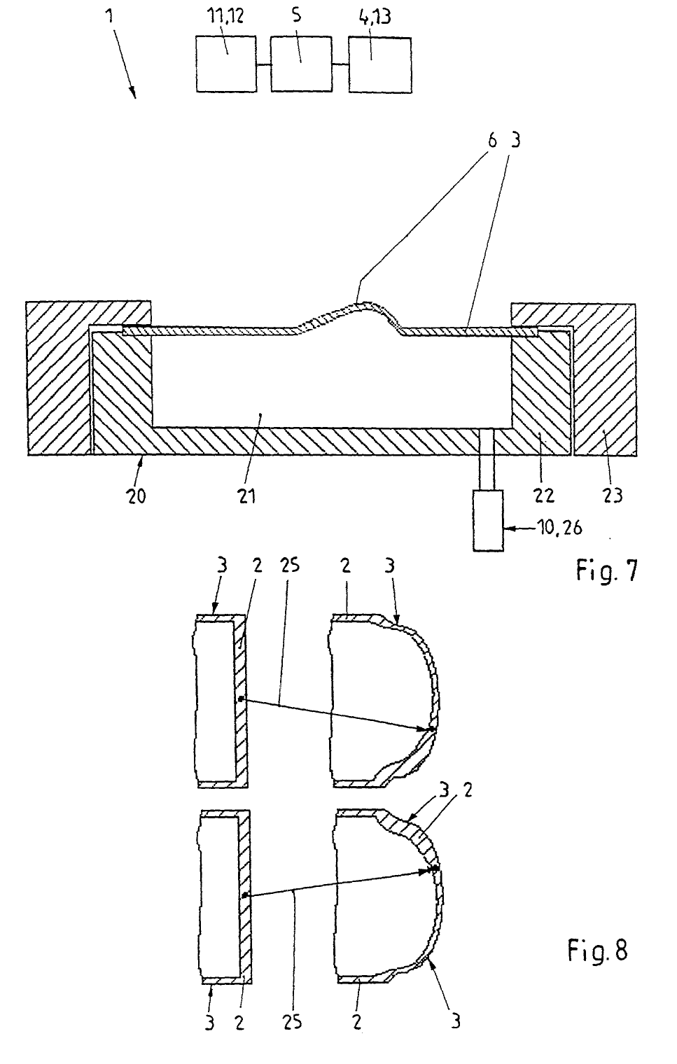

FIG. 7 illustrates the body 3 according to FIG. 6 after the deformation in the deformation zone 6 has taken place.

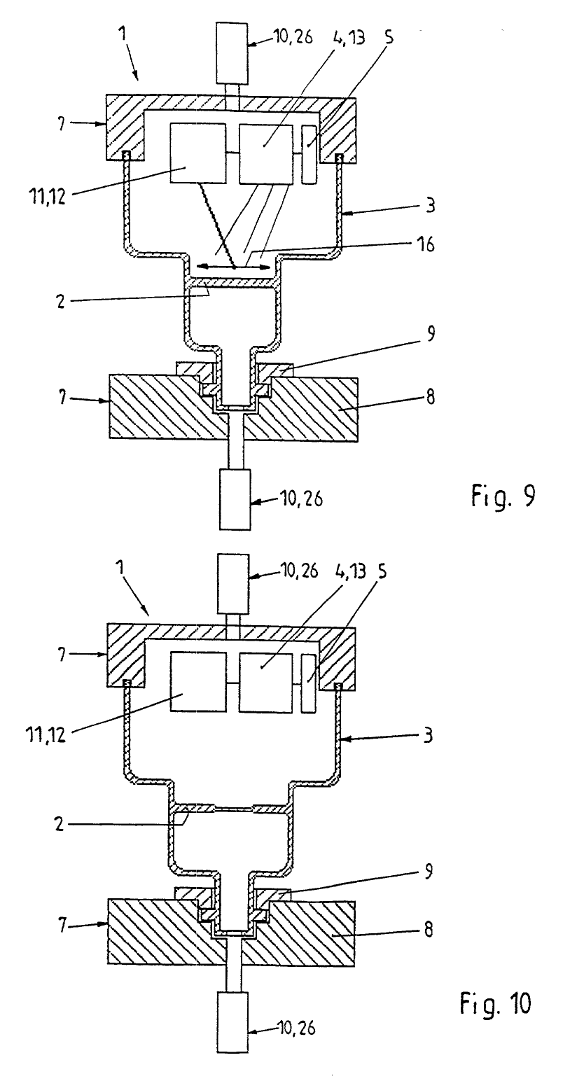

FIG. 8 illustrates two identical bodies 3 in the state before deformation and two very different finished bodies 3. In this way, it is clear that the same outer geometry of the body 3 at different wall thickness may be reached by a respective choice of the deformation zones 6. The arrow 25 clarifies in which direction the material of the body 3 has moved. FIGS. 9 and 10 illustrate a third embodiment of the apparatus 1 with a body 3 including a double chamber. The apparatus 1 includes two separate clamping apparatuses 7 and separate compressed air apparatuses 10 each being connected to the chambers of the body 3. The two chambers of the body 3 are separated by the thin side wall 2 of the body 3 in the form of an inner wall. The pressure within the two chambers of the body 3 is more than the ambient pressure. Due to the pressure conditions, the thin inner side wall 2 of the body 3 is lengthened after the application of energy.

Many variations and modifications may be made to the preferred embodiments of the invention without departing substantially from the spirit and principles of the invention. All such modifications and variations are intended to be included herein within the scope of the present invention, as defined by the following claims.

I claim:

1. An automated method of shaping a thin side wall of a body without cutting, said method comprising the steps of:
predetermining a desired geometry of the thin side wall of the body in an electronic data model;
automated determining the actual geometry of the thin side wall of the body and storing it in an electronic data model;
calculating the difference between the desired geometry and the actual geometry of the thin side wall of the body;
determining local deformation zones in which the difference between the desired geometry and the actual geometry of the thin side wall of the body exceeds a defined predetermined limiting value;
calculating an energy profile to be locally applied in the local deformation zones by numerical methods;
applying defined pressure to one side of the thin side wall of the body; and
defined, automated increasing the deformability of the thin side wall of the body in the local deformation zones by a defined application of energy in the local deformation zones in accordance with the calculated local energy profile, the thin side wall of the body in the local deformation zones being deformed due to its increased deformability and the one-side application of pressure.

2. The method of claim 1, wherein the body is shaped without using a form.

3. The method of claim 1, wherein the defined pressure is applied to the one side of the thin side wall of the body by compressed air of defined pressure.

4. The method of claim 2, wherein the defined pressure is applied to the one side of the thin side wall of the body by compressed air of defined pressure.

5. The method of claim 1, wherein the defined pressure is applied to the one side of the thin side wall of the body by a hydraulic medium of defined pressure.

6. The method of claim 2, wherein the defined pressure is applied to the one side of the thin side wall of the body by a hydraulic medium of defined pressure.

7. The method of claim 1, wherein the actual geometry of the thin side wall of the body is continuously determined, and wherein the application of energy in the local deformation zones is controlled with respect to the continuously determined actual geometry of the thin side wall of the body.

8. The method of claim 2, wherein the actual geometry of the thin side wall of the body is continuously determined, and wherein the application of energy in the local deformation zones is controlled with respect to the continuously determined actual geometry of the thin side wall of the body.

9. The method of claim 3, wherein the actual geometry of the thin side wall of the body is continuously determined, and wherein the application of energy in the local deformation zones is controlled with respect to the continuously determined actual geometry of the thin side wall of the body.

10. The method of claim 4, wherein the actual geometry of the thin side wall of the body is continuously determined, and wherein the application of energy in the local deformation zones is controlled with respect to the continuously determined actual geometry of the thin side wall of the body.

11. The method of claim 1, wherein the energy profile to be locally applied in the local deformation zones is newly calculated for each step of deformation in the local deformation zones.

12. The method of claim 2, wherein the energy profile to be locally applied in the local deformation zones is newly calculated for each step of deformation in the local deformation zones.

13. The method of claim 3, wherein the energy profile to be locally applied in the local deformation zones is newly calculated for each step of deformation in the local deformation zones.

14. The method of claim 4, wherein the energy profile to be locally applied in the local deformation zones is newly calculated for each step of deformation in the local deformation zones.

15. The method of claim 1, wherein the thin side wall of the body has a thickness which is varied by purposefully choosing the respective local deformation zone.

16. The method of claim 1, wherein the de fined application of energy in the local deformation zones in accordance with the calculated local energy profile is realized by a laser beam.

17. The method of claim 16, wherein the deformability of the thin side wall of the body is varied by a variation of the term of usage of the laser beam.

18. The method of claim 16, wherein the deformability of the thin side wall of the body is varied by a variation of the intensity of the laser beam.

19. The method of claim 16, wherein the deformability of the thin side wall of the body is varied by a variation of the pulse width of the laser beam.

20. The method of claim 16, wherein the deformability of the thin side wall of the body is varied by a variation of the focus size of the laser beam.

21. The method of claim 1, further comprising the step of cooling the local deformation zones after the desired deformation of the thin side wall of the body has been reached.

22. An automated method of shaping a thin side wall of a body without cutting, said method comprising the steps of:
predetermining a desired geometry of the thin side wall of the body in an electronic data model;
automated determining the actual geometry of the thin side wall of the body and storing it in an electronic data model;
calculating the difference between the desired geometry and the actual geometry of the thin side wall of the body;
determining local deformation zones in which the difference between the desired geometry and the actual geometry of the thin side wall of the body exceeds a defined predetermined limiting value;
calculating an energy profile to be locally applied in the local deformation zones by numerical methods;
applying defined pressure to one side of the thin side wall of the body by compressed air; and
defined, automated increasing the deformability of the thin side wall of the body in the local deformation zones by a defined application of energy in the local deformation zones in accordance with the calculated local energy profile by a laser beam, the thin side wall of the body in the local deformation zones being deformed due to its increased deformability and the one-side application of pressure.

23. An apparatus for shaping a body having at least one thin side wall without cutting, comprising:
a unit being designed and arranged to automatedly determine and store the actual geometry of the thin side wall of the body in an electronic data model;
a computer being designed and arranged to predetermine a desired geometry of the thin side wall of the body in an electronic data model, to calculate the difference between the desired geometry and the actual geometry by a comparison of the determined actual geometry and the predetermined desired geometry of the thin side wall of the body, to determine local deformation zones in which the difference between the desired geometry and the actual geometry of the thin side wall of the body exceeds a defined predetermined limiting value and to calculate an energy profile to be locally applied in the local deformation zones;
a controllable pressure unit being designed and arranged to apply defined pressure to one side of the thin side wall of the body; and
a unit being designed and arranged to increase the deformability of the thin side wall of the body in the local deformation zones in a defined, automated way by a defined application of energy in the local deformation zones in accordance with the calculated local energy profile, the thin side wall of the body in the local deformation zones being deformed due to its increased deformability and the one-side application of pressure.

24. The apparatus of claim 23, wherein said controllable pressure unit is a compressed air unit and said unit being designed and arranged to increase the deformability of the thin side wall of the body is a laser.

25. The apparatus of claim 23, wherein said unit being designed and arranged to automatedly determine and store the actual geometry of the thin side wall of the body includes a 3-D object measuring system.

26. The apparatus of claim 24, wherein said unit being designed and arranged to automatedly determine and store the actual geometry of the thin side wall of the body includes a 3-D object measuring system.

27. An apparatus for shaping a body having at least one thin side wall without cutting, comprising:
a unit being designed and arranged to automatedly determine and store the actual geometry of the thin side wall of the body in an electronic data model;
a computer being designed and arranged to predetermine a desired geometry of the thin side wall of the body in an electronic data model, to calculate the difference between the desired geometry and the actual geometry by a comparison of the determined actual geometry and the predetermined desired geometry of the thin side wall of the body, to determine local deformation zones in which the difference between the desired geometry and the actual geometry of the thin side wall of the body exceeds a defined predetermined limiting value and to calculate an energy profile to be locally applied in the local deformation zones;
a controllable compressed air unit being designed and arranged to apply defined pressure to one side of the thin side wall of the body; and
a laser being designed and arranged to increase the deformability of the thin side wall of the body in the local deformation zones in a defined, automated way by a defined application of energy in the local deformation zones in accordance with the calculated local energy profile by a laser beam, the thin side wall of the body in the local deformation zones being deformed due to its increased deformability and the one-side application of pressure.
